(19) United States
(12) Patent Application Publication
(10) Pub. No.: US 2015/0185948 A1
(43) Pub. Date: Jul. 2, 2015

(54) ELECTRONIC WRITING APPARATUS AND DRIVING METHOD THEREOF

(71) Applicant: E Ink Holdings Inc., Hsinchu (TW)

(72) Inventor: Yung-Sheng Chang, Hsinchu (TW)

(21) Appl. No.: 14/548,308

(22) Filed: Nov. 20, 2014

(30) Foreign Application Priority Data
Dec. 27, 2013 (TW) 102148784

(51) Int. Cl. G06F 3/041; G09G 3/34; G06F 3/044

(52) U.S. Cl. CPC G06F 3/0416; G06F 3/044; G09G 3/3446

(57) ABSTRACT

An electronic writing apparatus, including a first substrate, a second substrate disposed opposite to the first substrate, a display medium layer disposed between the first substrate and the second substrate, a first electrode disposed between the first substrate and the display medium layer, a second electrode disposed between the display medium layer and the second substrate, and spacers, is provided. The display medium layer includes charged particles, an electrophoretic liquid, and micro structures. Each of the micro structures surrounds a portion of the charged particles and a portion of the electrophoretic liquid. The spacers are disposed between the display medium layer and the second electrode and lean against a portion of the micro structures such that a changeable gap is formed between the display medium layer and the second electrode. Moreover, a driving method used to drive the electronic writing apparatus is also provided.

### CROSS-REFERENCE TO RELATED APPLICATION

This application claims the priority benefit of Taiwan application serial no. 102148784, filed on Dec. 27, 2013. The entirety of the above-mentioned patent application is hereby incorporated by reference herein and made a part of this specification.

### BACKGROUND OF THE INVENTION

1. Field of the Invention

The invention relates to an electronic apparatus and a driving method thereof, and more particularly relates to an electronic writing apparatus and a driving method thereof.

2. Description of Related Art

Traditional writing devices, such as ball-point pen and paper, are cheaper but less environmentally friendly for the used paper can no longer be used for writing again. There is another type of traditional writing device, such as whiteboard and whiteboard marker, which is reusable, for the writing on the whiteboard can be erased easily. However, permanent markers emit odor that may cause harm to human bodies.

In view of the above, new writing apparatuses, such as cholesteric liquid crystal writing apparatus, have been developed. Typically, the user can use his finger to write words on the cholesteric liquid crystal writing apparatus. However, if one of the strokes is incorrect, the current cholesteric liquid crystal writing apparatus does not allow the user to erase only the incorrect stroke. Instead, all the words on the cholesteric liquid crystal writing apparatus will be erased together with the incorrect stroke, which is inconvenient for the user.

### SUMMARY OF THE INVENTION

The invention provides an electronic writing apparatus for the user to partially erase writing in a designated area, which is more convenient to use.

The invention further provides a driving method for the electronic writing apparatus, by which the user is able to partially erase writing in a designated area.

An electronic writing apparatus of the invention includes a first substrate, a second substrate disposed opposite to the first substrate, a display medium layer disposed between the first substrate and the second substrate, a first electrode disposed between the first substrate and the display medium layer, a second electrode disposed between the display medium layer and the second substrate, and a plurality of spacers. The display medium layer includes a plurality of charged particles, an electrophoretic liquid, and a plurality of micro structures. Each of the micro structures surrounds a portion of the charged particles and a portion of the electrophoretic liquid. The spacers are disposed between the display medium layer and the second electrode and form a changeable gap between the display medium layer and the second electrode.

A driving method of the invention is adapted for driving the aforementioned electronic writing apparatus. The driving method includes the following: rendering a potential difference between the second electrode and the first electrode a negative value such that the electronic writing apparatus is in one of a writing mode and an erase mode; and when the electronic writing apparatus is in one of the writing mode and the erase mode, reducing the gap such that a portion of the display medium layer contacts with and is driven by the second electrode.

In an embodiment of the invention, the electronic writing apparatus further includes a pixel electrode array. The pixel electrode array is disposed between the spacers and the display medium layer. The pixel electrode array includes a plurality of pixel electrodes separated from each other.

In an embodiment of the invention, at least one of the pixel electrodes is electrically connected with the second electrode when the changeable gap is reduced.

In an embodiment of the invention, the charged particles include a plurality of positive charged particles and a plurality of negative charged particles, and a color of the positive charged particles is different from a color of the negative charged particles.

In an embodiment of the invention, the color of the positive charged particles is one of white and black, and the color of the negative charged particles is the other one of white and black.

In an embodiment of the invention, the electrophoretic liquid is transparent.

In an embodiment of the invention, the charged particles are a plurality of positive charged particles or a plurality of negative charged particles, and the color of the charged particles is different from a color of the electrophoretic liquid.

In an embodiment of the invention, the color of the charged particles is one of white and black.

In an embodiment of the invention, the color of the electrophoretic liquid is the other one of white and black.

In an embodiment of the invention, the electrophoretic liquid is colored.

In an embodiment of the invention, each of the micro structures is a micro-capsule or a micro-cup.

In an embodiment of the invention, at least one micro structure that is not leant against by any spacer exists between two adjacent spacers.

In an embodiment of the invention, the electronic writing apparatus further includes a driving unit electrically connected with the first electrode and the second electrode. The driving unit renders the potential difference between the second electrode and the first electrode a negative value such that the electronic writing apparatus is in one of the writing mode and the erase mode. The driving unit renders the potential difference between the second electrode and the first electrode a positive value such that the electronic writing apparatus is in the other one of the writing mode and the erase mode.

In an embodiment of the invention, the step of reducing the gap such that the portion of the display medium layer is driven by the second electrode includes: pressing the first substrate with an object to bend the portion of the display medium layer toward the second substrate to be in contact with the second electrode; or pressing the second substrate with the object to bend the second substrate toward the first substrate to cause the second electrode to be in contact with the portion of the display medium layer.

In an embodiment of the invention, the step of reducing the gap such that the portion of the display medium layer is driven by the second electrode includes: pressing the first substrate with an object to move at least one of the pixel electrodes toward the second substrate to be in contact with the second electrode; or pressing the second substrate with the object to bend the second substrate toward the first substrate to cause the second electrode to be in contact with at least one of the pixel electrodes.

In an embodiment of the invention, the driving method further includes the following: electrically insulating the display medium layer from the second electrode; rendering the potential difference between the second electrode and the first electrode a positive value such that the electronic writing apparatus is in the other one of the writing mode and the erase mode; and when the electronic writing apparatus is in the other one of the writing mode and the erase mode, reducing the gap such that a portion of the display medium layer is driven by the second electrode.

Based on the above, in the electronic writing apparatus according to an embodiment of the invention, multiple spacers are disposed between the display medium layer and the second electrode for forming the changeable gap between the display medium layer and the second electrode. The changeable gap is reduced when the electronic writing apparatus is pressed by the user, such that the second electrode drives a portion of the display medium layer corresponding thereto. With the aforementioned configuration, using the electronic writing apparatus together with the driving method of an embodiment of the invention allows the user to partially erase the writing in the designated area, which is more convenient for the user.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic cross-sectional view of an electronic writing apparatus according to the first embodiment of the invention.

FIG. 2 is a schematic cross-sectional view of an electronic writing apparatus according to another embodiment of the invention.

FIG. 3A to FIG. 3D are schematic views showing a driving method for the electronic writing apparatus of FIG. 1.

FIG. 4A to FIG. 4D are schematic views showing another driving method for the electronic writing apparatus of FIG. 1.

FIG. 5A is a schematic cross-sectional view of an electronic writing apparatus according to the second embodiment of the invention.

FIG. 5B is a schematic cross-sectional view of another part of the electronic writing apparatus of FIG. 5A.

FIG. 6A to FIG. 6D are schematic views showing a driving method for the electronic writing apparatus of FIG. 5A.

FIG. 7A to FIG. 7D are schematic views showing another driving method for the electronic writing apparatus of FIG. 5A.

FIG. 8 is a schematic cross-sectional view of an electronic writing apparatus according to the third embodiment of the invention.

FIG. 9 is a schematic cross-sectional view of an electronic writing apparatus according to another embodiment of the invention.

FIG. 10 is a schematic cross-sectional view of an electronic writing apparatus according to the fourth embodiment of the invention.

FIG. 11 is a schematic cross-sectional view of an electronic writing apparatus according to another embodiment of the invention.

### DESCRIPTION OF THE EMBODIMENTS

### First Embodiment

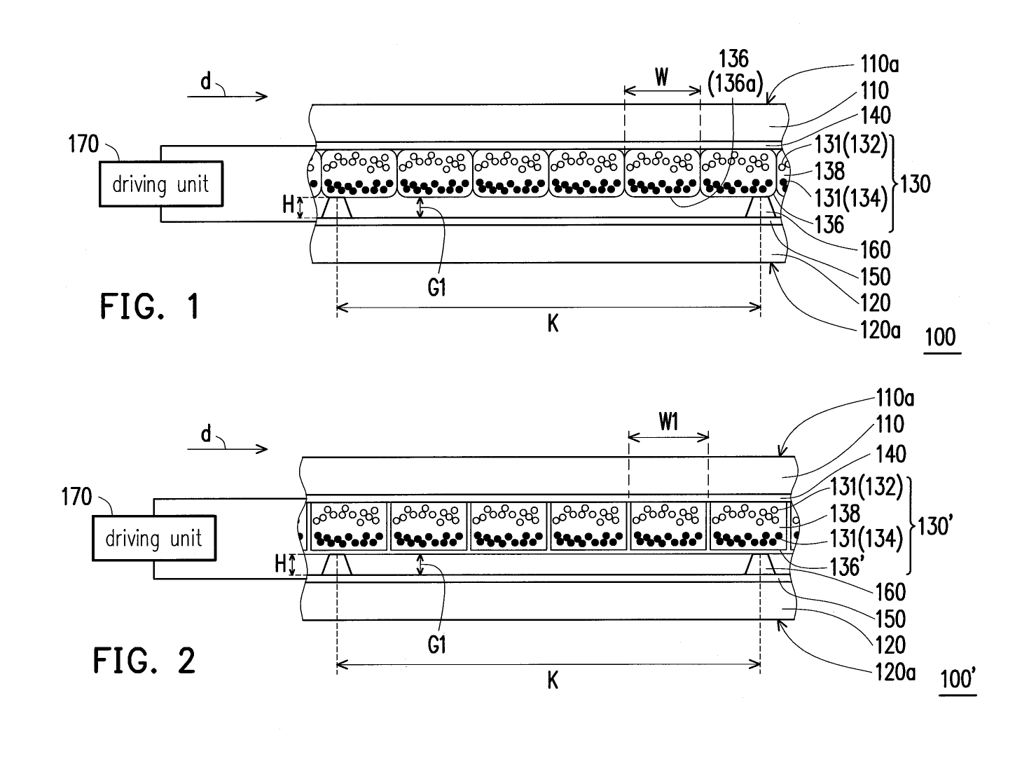

FIG. 1 is a schematic cross-sectional view of an electronic writing apparatus according to the first embodiment of the invention. With reference to FIG. 1, an electronic writing apparatus 100 of this embodiment includes a first substrate 110, a second substrate 120 disposed opposite to the first substrate 110, a display medium layer 130 disposed between the first substrate 110 and the second substrate 120, a first electrode 140 disposed between the first substrate 110 and the display medium layer 130, a second electrode 150 disposed between the display medium layer 130 and the second substrate 120, and a plurality of spacers 160. The display medium layer 130 includes a plurality of charged particles 131, a plurality of micro structures 136, and an electrophoretic liquid 138. Each of the micro structures 136 surrounds a portion of the charged particles 131 and a portion of the electrophoretic liquid 138. The spacers 160 are disposed between the display medium layer 130 and the second electrode 150, and lean against a portion of the micro structures 136, so as to form a changeable gap G1 between the display medium layer 130 and the second electrode 150. In this embodiment, the first electrode 140 and the second electrode 150 may respectively cover the first substrate 110 and the second substrate 120 entirely. However, the invention is not limited thereto.

In this embodiment, the micro structures 136 may be a plurality of micro-capsules, and a width W of each of the micro-capsules is in a range of 20 micrometers to 70 micrometers. Generally speaking, the micro-capsules do not necessarily have equal widths W. If the micro-capsules have different sizes, the micro-capsules in different sizes may be arranged randomly and not limited to a specific sequence or arrangement.

However, the invention is not limited thereto. FIG. 2 is a schematic cross-sectional view of an electronic writing apparatus according to another embodiment of the invention. With reference to FIG. 2, in an electronic writing apparatus 100′, multiple micro structures 136′ of a display medium layer 130′ may be a plurality of micro-cups or other suitable structures, wherein the micro-cups may be formed by printing. A width W1 of each of the micro-cups is about 100 micrometers, for example. It is worth mentioning that other components of the electronic writing apparatus 100′ may be designed to be the same as the components of the electronic writing apparatus 100. Therefore, the following paragraphs only specify the electronic writing apparatus 100.

With reference to FIG. 1, an insulating material or a high-impedance and pressure-resistant material, such as transparent resin, silicon oxide, silicon nitride, and silicon oxynitride, may be used as a material of the spacers 160 of this embodiment; however, the invention is not limited thereto. In other embodiments, other suitable materials may be used to form the spacers 160. The spacers 160 are disposed to separate the display medium layer 130 and the second electrode 150, such that the display medium layer 130 is electrically insulated from the second electrode 150 when the user is not operating the electronic writing apparatus 100 (i.e., no external force is applied on the electronic writing apparatus 100).

To be more specific, the spacers 160 of this embodiment have a height H, which is sufficient to maintain the changeable gap G1 between the display medium layer 130 and the second electrode 150. Thus, in a situation that the gap G1 is not reduced, an electric field generated by the second electrode 150 and the first electrode 140 is insufficient to change the positions of the charged particles 131 in the display medium layer 130. For instance, the height H of the spacer 160 is in a range of 5 micrometers to 5 millimeters. In other embodiments, the height H of the spacer 160 may be in a range of 10 micrometers to 5 millimeters.

In addition, it is known from FIG. 1 that the spacers 160 does not lean against a portion of the micro structures 136a. To be more specific, at least one micro structure 136a is not leant by any spacer 160 and is located between two adjacent spacers 160. As shown in FIG. 1, at least four micro structures 136a are not leant by any spacer 160 and are located between two adjacent spacers 160. When the electronic writing apparatus 100 is not operated by the user, a proper configuration of the spacers 160 prevents the display medium layer 130 from descending due to the weight of the display medium layer 130, the first electrode 140, and the first substrate 110, thereby preventing electrical connection with the second electrode 150. Moreover, the proper configuration of the spacers 160 allows the user to perform a writing or erasing operation without an excessive force when operating the electronic writing apparatus 100. For example, in this embodiment, the spacers 160 may be arranged uniformly in an array on the second electrode 150. Nevertheless, the invention is not limited thereto. In other embodiments, the spacers 160 may be disposed in other suitable arrangements, such as being disposed randomly or in accordance with a specific rule on the second electrode 150.

More specifically, an interval K between two adjacent spacers 160 is at least greater than the width W of one micro structure 136a, wherein the width W refers to a width of the micro structure 136a in a direction d parallel to the first substrate 110, and the interval K refers to a distance between centers of two adjacent spacers 160 in the direction d parallel to the first substrate 110. For example, in this embodiment, the interval K between two adjacent spacers 160 is in a range of 200 micrometers to 20 millimeters. It should be noted that the values of the height H, the interval K, and the widths W and W1 are given as examples for illustrating the invention and should not be construed as limitations to the invention. For instance, the interval K may be set to a range of 1 millimeter to 10 millimeters.

In this embodiment, the charged particles 131 include positive charged particles 132 and negative charged particles 134. Each of the micro structures 136 surrounds a portion of the positive charged particles 132 and a portion of the negative charged particles 134. The positive charged particles 132 have a color that is different from a color of the negative charged particles 134. For example, in this embodiment, the color of the positive charged particles 132 is white and the color of the negative charged particles 134 is black. However, the invention is not limited thereto. In other embodiments, the colors of the positive charged particles 132 and the negative charged particles 134 may be switched. In addition, the colors of the positive charged particles 132 and the negative charged particles 134 are not necessarily black and white. The positive charged particles 132 and the negative charged particles 134 may be black, white, or any other two colors (e.g., red, blue, green, yellow, etc.) that are distinguishable to the user's naked eyes. The electrophoretic liquid 138 of this embodiment is a transparent liquid. Therefore, the colors displayed by the electronic writing apparatus 100 are determined by the charged particles 131. However, the invention is not limited thereto. In other embodiments, the electrophoretic liquid 138 may be an opaque liquid, such as a black or colored liquid. In other embodiments, the colors displayed by the electronic writing apparatus 100 may be determined by the charged particles 131 and the opaque electrophoretic liquid 138.

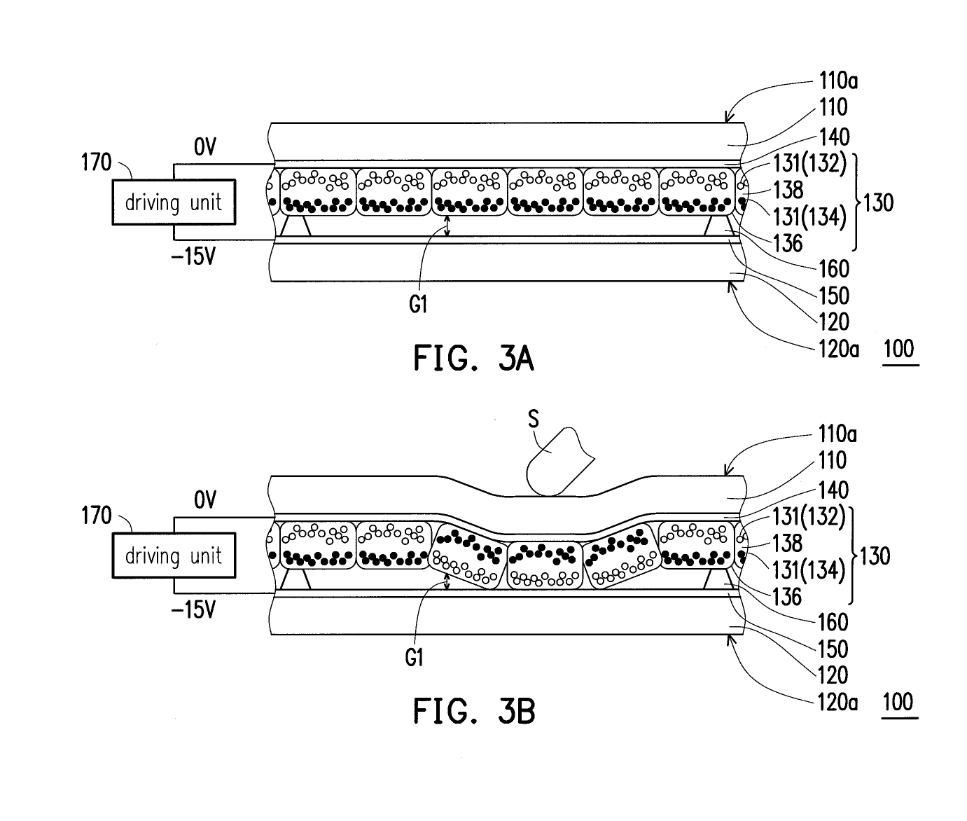

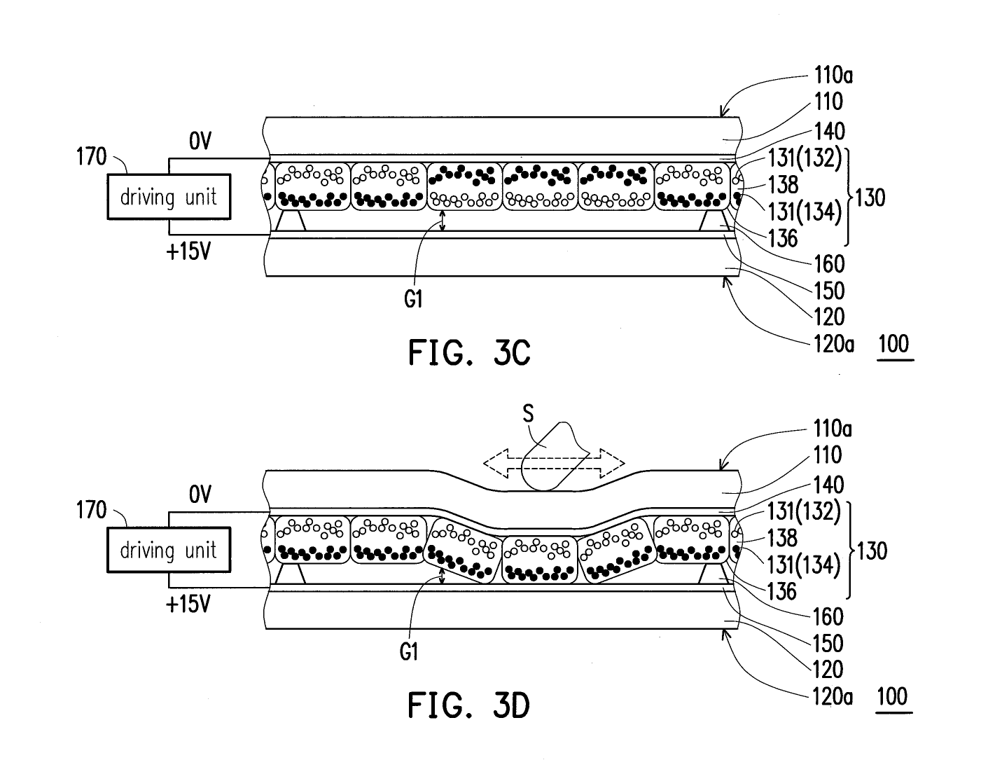

In this embodiment, the electronic writing apparatus 100 further includes a driving unit 170 electrically connected to the first electrode 140 and the second electrode 150. Below how the driving unit 170 drives the electronic writing apparatus 100 is explained with reference to FIG. 3A to FIG. 3D.

FIG. 3A to FIG. 3D are schematic views showing a driving method for the electronic writing apparatus of FIG. 1. With reference to FIG. 3A, first, the driving unit 170 renders a potential difference between the second electrode 150 and the first electrode 140 a negative value (wherein the potential difference is calculated by subtracting a voltage of one of the first electrode 140 and the second electrode 150 which is close to the user from a voltage of the other one of the first electrode 140 and the second electrode 150 which is away from the user; in FIG. 3A, the voltage difference is −15V), such that the electronic writing apparatus 100 is in one of a writing mode or an erase mode. It should be noted that, when the potential difference between the second electrode 150 and the first electrode 140 is a negative value, whether the electronic writing apparatus 100 is in the writing mode or the erase mode is determined by an electric property of the particles that present a writing color.

For instance, in this embodiment, the writing color that is to be displayed by the electronic writing apparatus 100 is black as presented by the negative charged particles 134, and when the potential difference between the second electrode 150 and the first electrode 140 is a negative value, the electronic writing apparatus 100 is in the writing mode. However, in other embodiments, if the writing color to be displayed by the electronic writing apparatus 100 is white as presented by the positive charged particles 132, when the potential difference between the second electrode 150 and the first electrode 140 is a positive value, the electronic writing apparatus 100 is in the writing mode.

Referring to FIG. 3B, then, when the potential difference between the second electrode 150 and the first electrode 140 is maintained a negative value, the gap G1 is reduced, such that a portion of the display medium layer 130 is contacted with the second electrode 150 and driven by the voltage difference between the second electrode 150 and the first electrode 140. To be more specific, in this embodiment, an object S (e.g., a pen or finger, etc.) may be used to press the first substrate 110 so as to bend the first substrate 110 toward the second substrate 120 and cause a portion of the micro structures 136 in the display medium layer 130 to contact the second electrode 150. At the same time, the charged particles 131 in the portion of the micro structures 136 that are in contact with the second electrode 150 are driven by the second electrode 150 to change positions.

For example, in the portion of the micro structures 136 that are in contact with the second electrode 150, the black negative charged particles 134 move from a side close to the second substrate 120 toward a side close to the first substrate 110, and the white positive charged particles 132 move from the side close to the first substrate 110 toward the side close to the second substrate 120. Accordingly, when looking at the electronic writing apparatus 100 in a direction from the first substrate 110 to the second substrate 120, a portion of the electronic writing apparatus 100, which corresponds to a route pressed by the object S, shows black while other portions of the electronic writing apparatus 100 that are not pressed by the object S remain white. In other words, the electronic writing apparatus 100 displays a black writing corresponding to the route pressed by the object S, thereby completing the writing operation.

With reference to FIG. 3C, next, the display medium layer 130 is electrically insulated from the second electrode 150. More specifically, in this embodiment, when the object S leaves the first substrate 110, the first substrate 110 together with the display medium layer 130 is separated from the second electrode 150 due to an elastic restoring force of the first substrate 110, so as to recover the gap G1 to the size when no external force is applied on the electronic writing apparatus 100. Meanwhile, the display medium layer 130 is electrically insulated from the second electrode 150. In the micro structures 136 corresponding to the route that was pressed by the object S, the black negative charged particles 134 remain on the side close to the first substrate 110, and the electrode writing apparatus 100 still displays the back writing.

Then, the potential difference between the second electrode 150 and the first electrode 140 may be changed to a positive value (e.g., +15V), such that the electronic writing apparatus 100 is in one of the writing mode and the erase mode. To be more detailed, when the potential difference between the second electrode 150 and the first electrode 140 is a positive value, whether the electronic writing apparatus 100 is in the writing mode or the erase mode is determined by a background color that is to be displayed by the electronic writing apparatus 100.

For example, in this embodiment, the background color to be displayed by the electronic writing apparatus 100 is the white color of the positive charged particles 132, and when the potential difference between the second electrode 150 and the first electrode 140 is a positive value, the electronic writing apparatus 100 is in the erase mode. However, in other embodiments, if the background color to be displayed by the electronic writing apparatus 100 is the black color of the negative charged particles 134, when the potential difference between the second electrode 150 and the first electrode 140 is a negative value, the electronic writing apparatus 100 is in the erase mode.

With reference to FIG. 3D, next, in a situation that the potential difference between the second electrode 150 and the first electrode 140 is maintained a positive value, the gap G1 is reduced again, such that a portion of the display medium layer 130 is driven by the potential difference between the second electrode 150 and the first electrode 140. More specifically, in this embodiment, the object S is used to press the first substrate 110 so as to bend a portion of the micro structures 136 in the display medium layer 130 toward the second substrate 120 to contact the second electrode 150. Meanwhile, the charged particles 131 in the portion of micro structures 136 that are in contact with the second electrode 150 are affected by the second electrode 150 and change positions. For example, in the portion of micro structures 136 that are in contact with the second electrode 150, the black negative charged particles 134 move from the side close to the first substrate 110 toward the side close to the second substrate 120, and the white positive charged particles 132 move from the side close to the second substrate 120 toward the side close to the first substrate 110. Accordingly, the portion of the electronic writing apparatus 100, which corresponds to the route pressed by the object S, is restored to white, thereby completing the operation of erasing the writing.

As described above, in this embodiment, the portion pressed by the object S is restored to white only when the electronic writing apparatus 100 is in the erase mode. That is to say, the electronic writing apparatus 100 of this embodiment allows the user to partially erase the writing in a designated area, which is more convenient for the user.

As shown in FIG. 3B and FIG. 3D, in this embodiment, the user uses an external surface 110a of the first substrate 110 as a writing surface to be pressed by the object S. That is, in this embodiment, the first substrate 110 serves as a writing substrate, and the second substrate 120 serves as a carrier substrate. In this embodiment, a material of the writing substrate may be a translucent and flexible material, such as an organic polymer, etc. A material of the carrier substrate may be a flexible material or a rigid material, such as glass, quartz, or metal, etc. It is worth mentioning that, when the carrier substrate is made of a material having higher rigidity, the carrier substrate provides a greater reaction force to the writing substrate pressed by the object S. Therefore, the writing substrate has a greater elastic restoring force for quickly separating the display medium layer 130 from the second electrode 150. Accordingly, the electronic writing apparatus 100 can be operated more smoothly. In addition, when the carrier substrate is made of a material having higher rigidity, the carrier substrate may be used as a part of an external package structure of the electronic writing apparatus 100, so as to reduce the thickness of the electronic writing apparatus 100 after packaging and the package material costs.

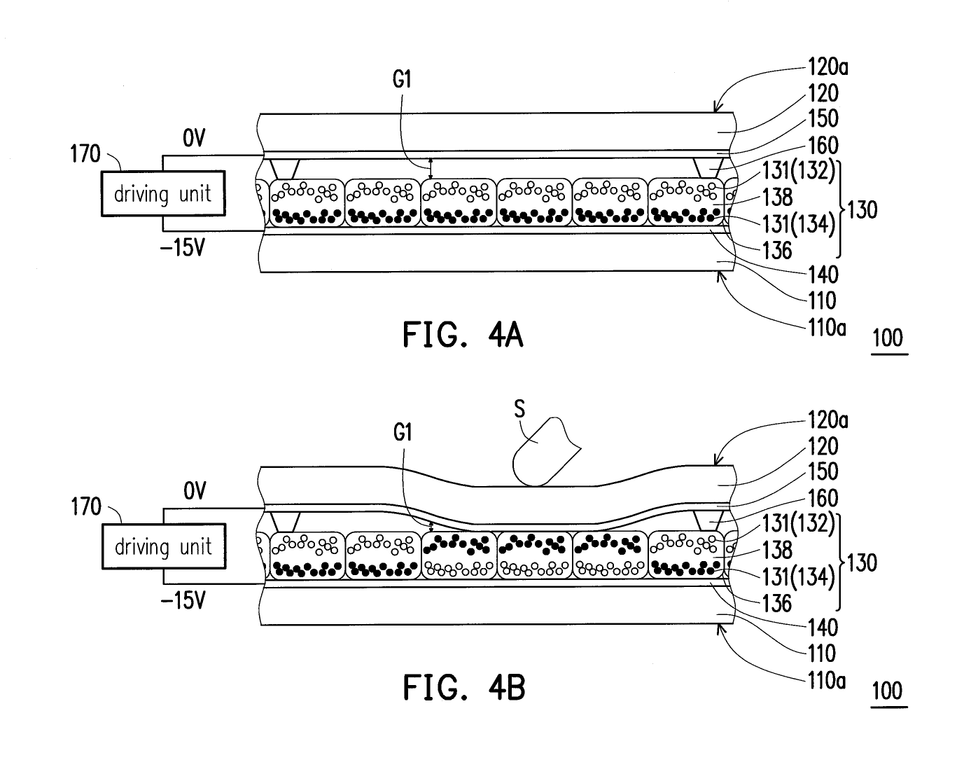

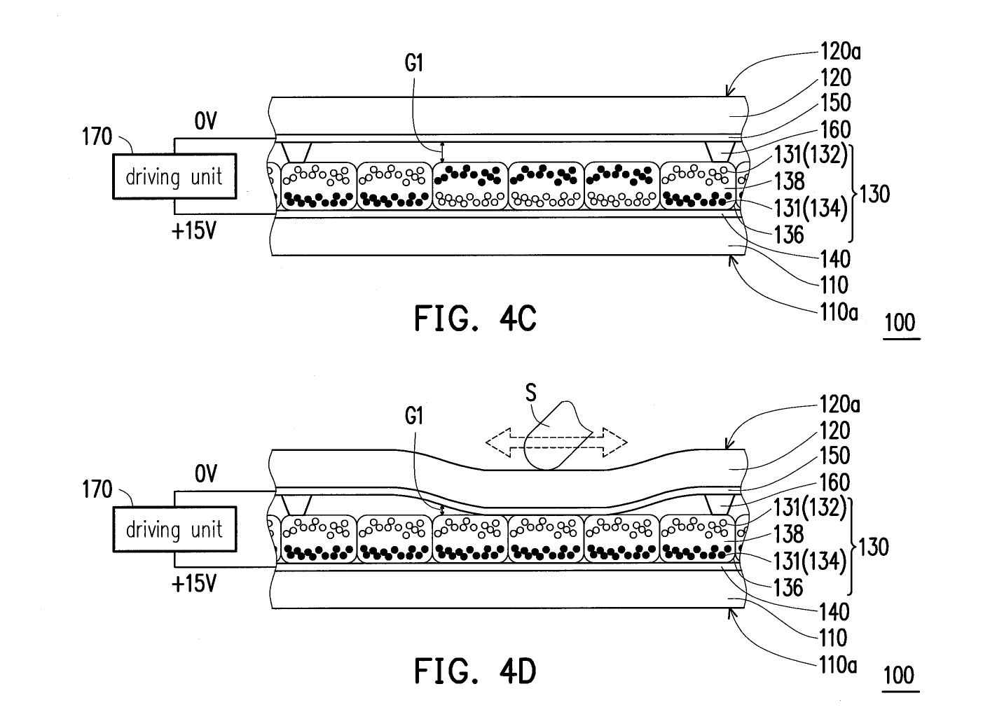

FIG. 4A to FIG. 4D are schematic views showing another driving method for the electronic writing apparatus of FIG. 1. The driving method as illustrated in FIG. 4A to FIG. 4D is similar to the driving method illustrated in FIG. 3A to FIG. 3D, and a main difference therebetween lies in that: in the driving method of FIG. 4A to FIG. 4D, the user presses the second substrate 120 to complete the writing or erasing operation. However, in the driving method of FIG. 4A to FIG. 4D, the second substrate 120 is used as the writing substrate while the first substrate 110 is used as the carrier substrate. That is to say, in this embodiment, the second substrate 120 needs to have a flexible property to be used as the writing substrate, and the first substrate 110 may selectively be a rigid substrate or a flexible substrate.

With reference to FIG. 4A, first, the driving unit 170 renders the potential difference between the second electrode 150 and the first electrode 140 a negative value (e.g., −15V), such that the electronic writing apparatus 100 is in the writing mode. With reference to FIG. 4B, next, while the potential difference between the second electrode 150 and the first electrode 140 is maintained a negative value, the gap G1 is reduced, such that a portion of the display medium layer 130 is in contact with the second electrode 150 and is driven by the second electrode 150 and the first electrode 140 to complete the writing operation.

To be more specific, the object S is used to press the second substrate 120 to bend the second substrate 120 toward the first substrate 110 and cause the second electrode 150 to be in contact with a portion of the micro structures 136 in the display medium layer 130. At the same time, in the portion of micro structures 136 that are in contact with the second electrode 150, the black negative charged particles 134 move from the side close to the first substrate 110 to the side close to the second substrate 120 while the white positive charged particles 132 move from the side close to the second substrate 120 to the side close to the first substrate 110. Accordingly, when looking at the electronic writing apparatus 100 in a direction from the second substrate 120 to the first substrate 110, a portion of the electronic writing apparatus 100, which corresponds to the route pressed by the object S, displays black writing, and other portions of the electronic writing apparatus 100 which are not pressed by the object S display white color, thereby completing the writing operation.

With reference to FIG. 4C, after completing the writing operation, the display medium layer 130 is electrically insulated from the second electrode 150. More specifically, in this embodiment, when the object S leaves the second substrate 120, the second substrate 120 together with the second electrode 150 is separated from the display medium layer 130 due to an elastic restoring force of the second substrate 120, so as to recover the gap G1 to the size when no external force is applied on the electronic writing apparatus 100. At this moment, the display medium layer 130 is electrically insulated from the second electrode 150, and the voltage difference between the first electrode 140 and the second electrode 150 does not drive the display medium layer 130. Then, the potential difference between the second electrode 150 and the first electrode 140 is rendered a positive value (e.g., +15V), such that the electronic writing apparatus 100 is in the erase mode.

With reference to FIG. 4D, next, while the potential difference between the second electrode 150 and the first electrode 140 is maintained a positive value, the gap G1 is reduced again, such that a portion of the micro structures 136 in the display medium layer 130 approach the second electrode 150 and are driven by the voltage difference between the first electrode 140 and the second electrode 150 to complete the erasing operation. To be more specific, the object S is used to press the second substrate 120 to bend the second substrate 120 toward the first substrate 110 and cause the second electrode 150 to be in contact with a portion of the micro structures 136.

At this moment, in the portion of micro structures 136 that are in contact with the second electrode 150, the black negative charged particles 134 move from the side close to the second substrate 120 to the side close to the first substrate 110 due to the voltage difference between the first electrode 140 and the second electrode 150. At the same time, the white positive charged particles 132 move from the side close to the first substrate 110 to the side close to the second substrate 120 due to the voltage difference between the first electrode 140 and the second electrode 150. Accordingly, when looking at the electronic writing apparatus 100 in the direction from the second substrate 120 to the first substrate 110, a portion of the electronic writing apparatus 100, which corresponds to a route pressed by the object S, is restored to white, thereby completing the operation of erasing the writing.

In the above embodiment, the writing mode and the erase mode may be performed alternately. Moreover, the user may switch the mode of the electronic writing apparatus 100 according to his needs. For example, if the user finds a stroke that needs to be corrected after making several writing strokes in the writing mode, the user can switch the electronic writing apparatus 100 to the erase mode for erasing the incorrect stroke. Then, if the user wants to continue editing or writing, he can switch the electronic writing apparatus 100 back to the writing mode for writing.

### Second Embodiment

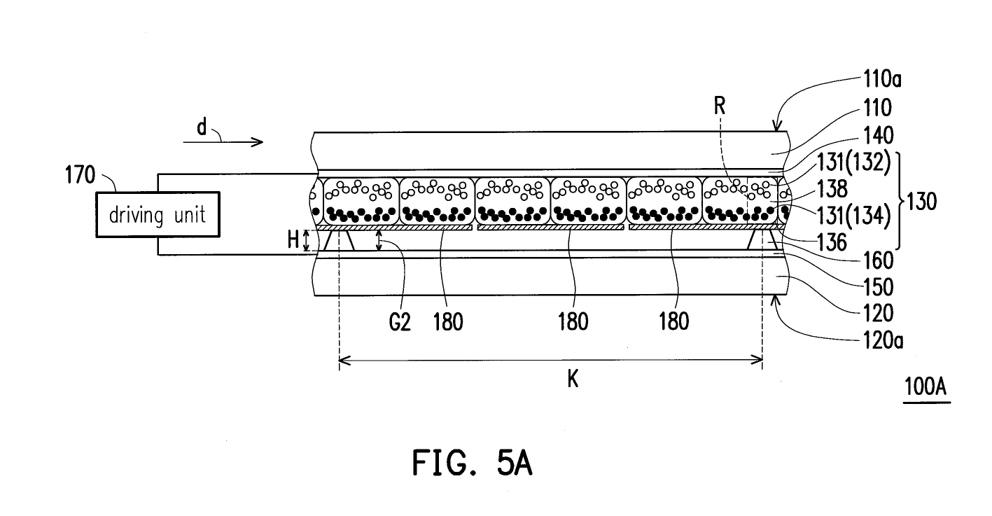

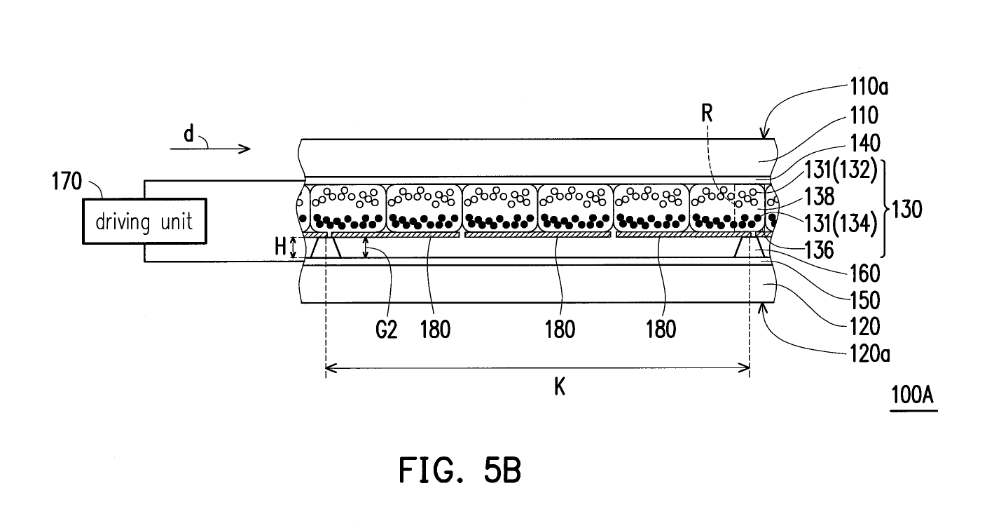

FIG. 5A is a schematic cross-sectional view of an electronic writing apparatus according to the second embodiment of the invention. With reference to FIG. 5A, an electronic writing apparatus 100A of this embodiment is similar to the electronic writing apparatus 100 of the first embodiment. Thus, the same components are assigned with the same reference numerals. The difference between the electronic writing apparatus 100A and the electronic writing apparatus 100 is explained hereinafter while the common parts will not be repeated again.

A difference between the electronic writing apparatus 100A of this embodiment and the electronic writing apparatus 100 lies in that: the electronic writing apparatus 100A further includes a pixel electrode array disposed between the spacers 160 and the display medium layer 130. The pixel electrode array includes a plurality of pixel electrodes 180 that are separated from each other. In this embodiment, the spacers 160 lean against a portion of the pixel electrodes 180.

Furthermore, in this embodiment, at least a portion of the pixel electrodes 180 partially overlap at least a portion of the spacers 160 corresponding thereto respectively, wherein the spacers 160 corresponding to the pixel electrodes 180 refer to the spacers 160 leaning against the pixel electrodes 180. To be more specific, as shown in FIG. 5A, the area of at least one pixel electrode 180 completely covers and go beyond the corresponding spacer 160. That is to say, the spacer 160 is within the area of the pixel electrode 180 that is leant against by the spacer 160. Nevertheless, the invention should not be construed as limited thereto. FIG. 5B is a schematic cross-sectional view of another part of the electronic writing apparatus of FIG. 5A. As shown in FIG. 5B, the pixel electrode 180 may not completely cover the corresponding spacer 160. That is, the spacer 160 may be disposed between multiple pixel electrodes 180. With reference to FIG. 5A and FIG. 5B, when the user is not operating the electronic writing apparatus 100A (i.e., when the user is not applying an external force on the electronic writing apparatus 100A), a changeable gap G2 is maintained between each pixel electrode 180 and the second electrode 150, and the pixel electrodes 180 are electrically insulated from each other. When the gap G2 is adjusted to be reduced, at least one pixel electrode 180 is electrically connected to the second electrode 150.

In this embodiment, all the pixel electrodes 180 may belong to the same layer. All the pixel electrodes 180 may have the same shape and size, such that the electronic writing apparatus 100A have uniform resolution in all areas. Moreover, each pixel electrode 180 may be correspondingly disposed on multiple micro structures 136. Thus, after a voltage is inputted to each pixel electrode 180, the charged particles 131 in the corresponding micro structures 136 are driven. However, the invention is not limited thereto. In other embodiments, the pixel electrodes 180 may have different areas and sizes, and each pixel electrode 180 may be selectively disposed on only one micro structure 136.

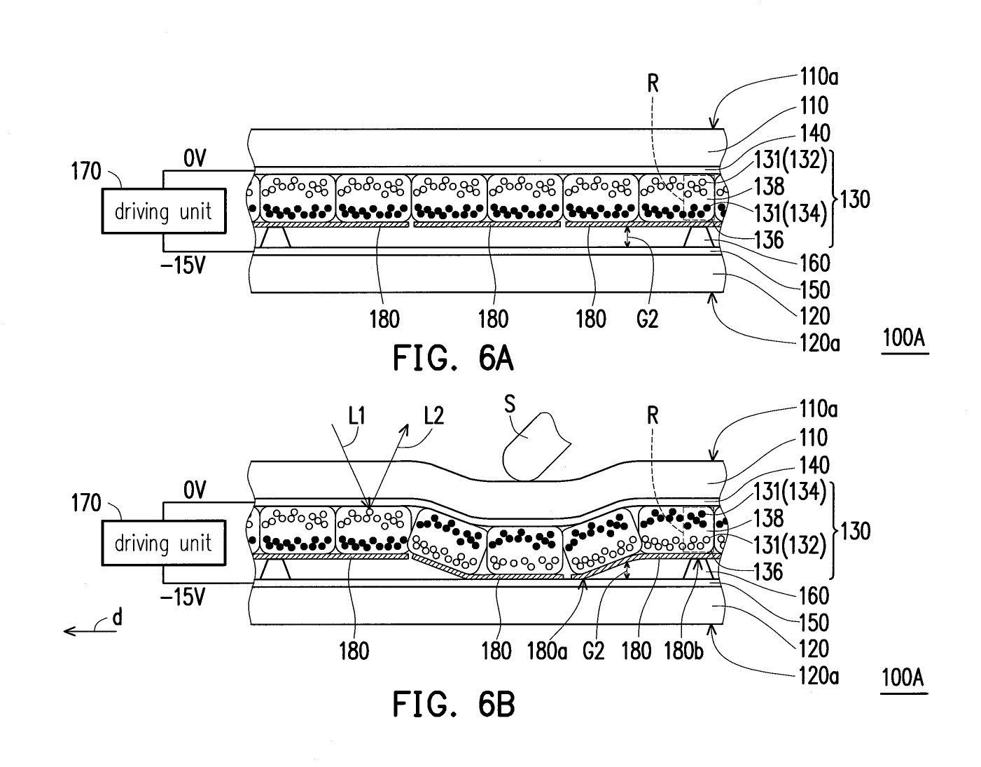

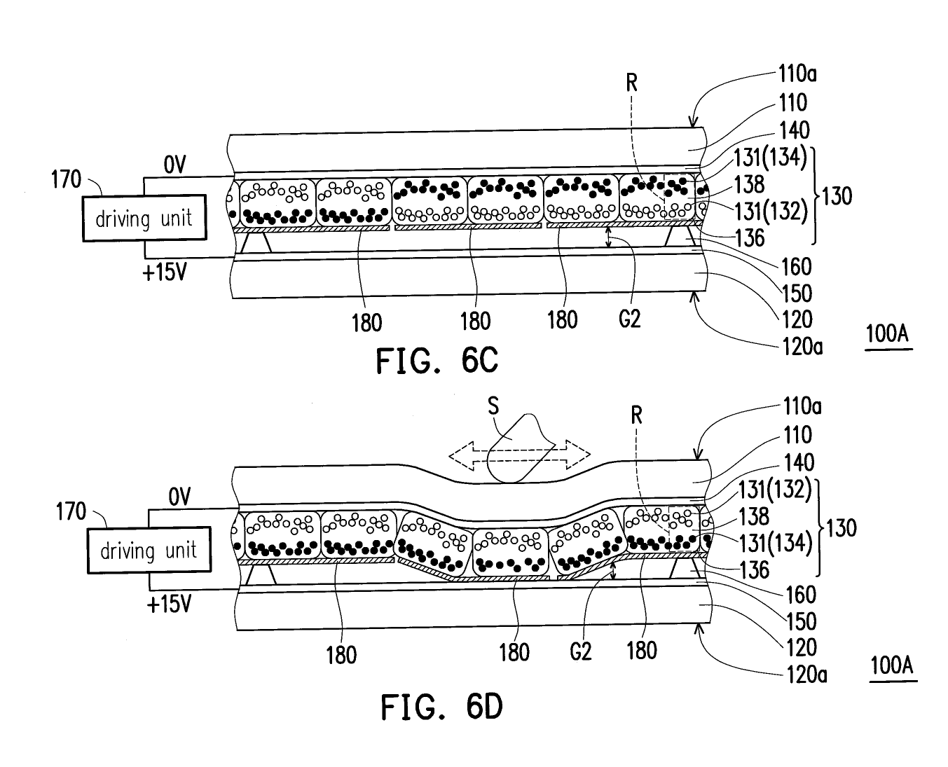

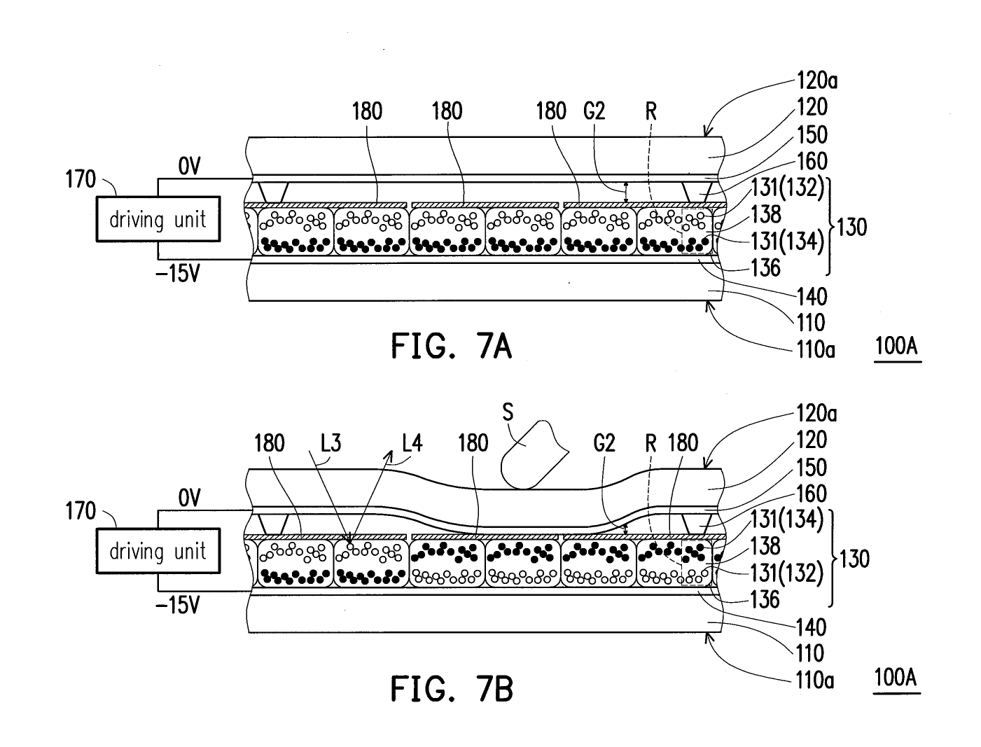

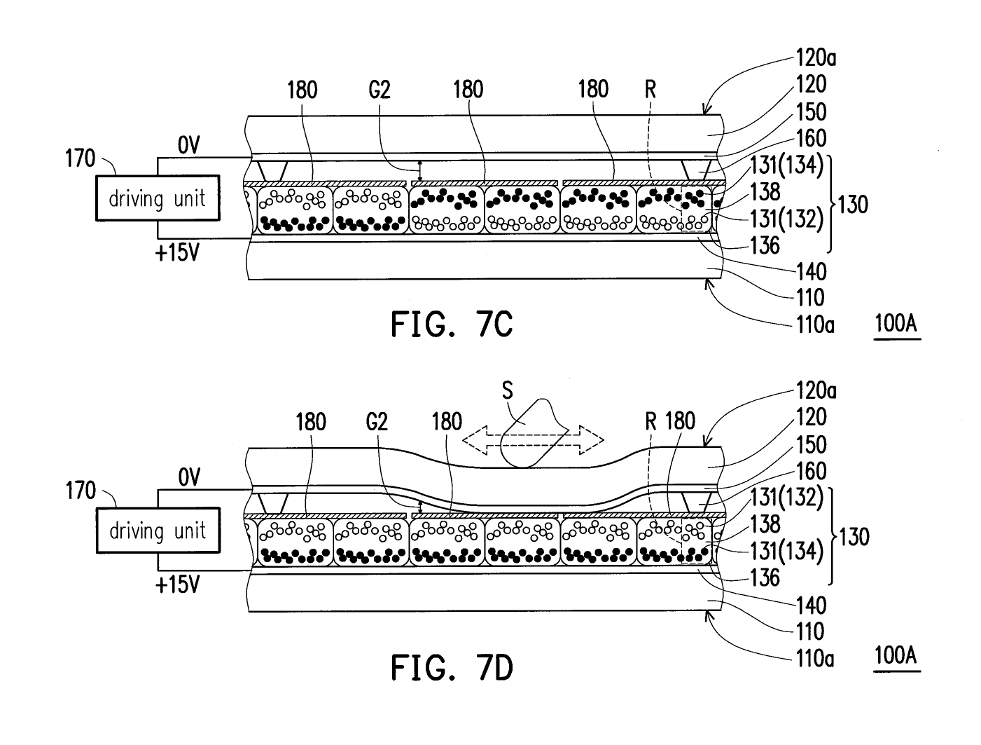

As being leaning against by the spacers 160, when the user operates the electronic writing apparatus 100A (i.e., the user applies an external force on the electronic writing apparatus 100A), a part R of the display medium layer 130 is blocked by the spacer 160 and kept from moving close to the second electrode 150. Thus, the part R of the display medium layer 130 is not effectively driven by the potential difference between the first electrode 140 and the second electrode 150 to display the writing. Hence, the electronic writing apparatus 100A overcomes the aforementioned program by disposing the pixel electrodes 180. Details are described hereinafter with reference to FIG. 6A to FIG. 6D and FIG. 7A to FIG. 7D.

FIG. 6A to FIG. 6D are schematic views showing a driving method for the electronic writing apparatus of FIG. 5A. With reference to FIG. 6A, first, the driving unit 170 renders the potential difference between the second electrode 150 and the first electrode 140 a negative value (e.g., −15V), such that the electronic writing apparatus 100A is in one of the writing mode and the erase mode. Here, the writing mode is described as an example.

With reference to FIG. 6B, next, while the potential difference between the second electrode 150 and the first electrode 140 is maintained a negative value, the gap G2 is reduced to bend the first substrate 110 toward the second substrate 120 and cause the second electrode 150 to be in contact with at least one pixel electrode 180, thereby completing the writing operation. To be more specific, in this embodiment, the object S (e.g., pen, finger, etc.) is used to press the first substrate 110, so as to move a portion of the pixel electrodes 180 close to the second electrode 150 or even in contact with the second electrode 150. At this moment, the pixel electrode 180 that is in contact with the second electrode 150 receives the voltage of the second electrode 150 and drives the positive charged particles 132 and the negative charged particles 134 packaged in the corresponding micro structures 136, so as to change the positions of the positive charged particles 132 and the negative charged particles 134.

For example, since the potential difference between the second electrode 150 and the first electrode 140 is maintained a negative value, in the portion of the micro structures 136 on the pixel electrode 180 that is in contact with the second electrode 150, the black negative charged particles 134 move from the side close to the second substrate 120 toward the side close to the first substrate 110, and the white positive charged particles 132 move from the side close to the first substrate 110 toward the side close to the second substrate 120. Accordingly, when looking at the electronic writing apparatus 100A in the direction from the first substrate 110 to the second substrate 120, a portion of the electronic writing apparatus 100A, which corresponds to a route pressed by the object S, and the part R show black. Meanwhile, other portions of the electronic writing apparatus 100A which are not pressed by the object S display white color, thereby completing the writing operation.

It is worth mentioning that, in the electronic writing apparatus 100A as shown in FIG. 6B, the part R of the display medium layer 130 is blocked by the spacer 160 and kept from moving close to the second electrode 150. However, the pixel electrode 180 disposed at the part R and exceeds the spacer 160 is allowed to contact the second electrode 150. Therefore, a portion 180a of the pixel electrode 180, which is in contact with the second electrode 150, transmits an electrical signal applied to the second electrode 150 to another portion 180b of the pixel electrode 180. The another portion 180b of the pixel electrode 180 then drives the charged particles 131 in the part R together with the first electrode 140 to achieve the desired effects. Accordingly, the part R blocked by the spacer 160 can still be used for displaying the writing made by the user.

In this embodiment, the user can look at the electronic writing apparatus 100A in the direction from the first substrate 110 to the second substrate 120. Here, an environment light beam L1 does not have to pass through the pixel electrode 180 and can still be reflected by the charged particles 131 as an image light beam L2 for forming an image in the eyes of the user. Hence, in this embodiment, an opaque conductive material, such as metal, alloy, graphite or a stack layer of metal and other conductive materials, may be used to form the pixel electrode 180. However, the invention is not limited thereto, and in other embodiments, the pixel electrode 180 may also be made of a conductive material having high light transmittance, which is described in the following embodiment with reference to FIG. 7A to FIG. 7D.

With reference to FIG. 6C, next, the display medium layer 130 is electrically insulated from the second electrode 150. More specifically, in this embodiment, when the object S leaves the first substrate 110, the first substrate 110 together with the display medium layer 130 and the pixel electrodes 180 is separated from the second electrode 150 due to an elastic restoring force of the first substrate 110, so as to recover the gap G2 to the size when no external force is applied on the electronic writing apparatus 100A. Meanwhile, the display medium layer 130 is electrically insulated from the second electrode 150. Then, the potential difference between the second electrode 150 and the first electrode 140 is changed to a positive value (e.g., +15V), such that the electronic writing apparatus 100A is the erase mode.

With reference to FIG. 6D, then, in a situation that the potential difference between the second electrode 150 and the first electrode 140 is maintained a positive value, the gap G2 is reduced again, such that a portion of the pixel electrodes 180 are electrically connected with the second electrode 150, thereby completing the erasing operation. More specifically, in this embodiment, the object S is used to press the first substrate 110, so as to move a portion of the pixel electrodes 180 close to the second substrate 120 and to be in contact with the second electrode 150. At this moment, the charged particles 131 in the portion of micro structures 136 on the pixel electrode 180 that is in contact with the second electrode 150 are driven by the voltage applied to the second electrode 150 through the pixel electrode 180 to change positions.

For example, since the potential difference between the second electrode 150 and the first electrode 140 is maintained a positive value, in the portion of the micro structures 136 on the pixel electrode 180 that is in contact with the second electrode 150, the black negative charged particles 134 move from the side close to the first substrate 110 toward the side close to the second substrate 120, and the white positive charged particles 132 move from the side close to the second substrate 120 toward the side close to the first substrate 110. Accordingly, when looking at the electronic writing apparatus 100A in the direction from the first substrate 110 to the second substrate 120, a portion of the electronic writing apparatus 100A, which corresponds to a route pressed by the object S, and the part R are restored to white, thereby completing the erasing operation.

In this embodiment, the user uses the external surface 110a of the first substrate 110 as the writing surface to be pressed by the object S. In other words, the first substrate 110 is the writing substrate. Nevertheless, the invention is not limited thereto. In other embodiments, the user may use an external surface 120a of the second substrate 120 as the writing surface to be pressed by the object S. Details are described hereinafter with reference to FIG. 7A to FIG. 7D.

FIG. 7A to FIG. 7D are schematic views showing another driving method for the electronic writing apparatus of FIG. 5A. With reference to FIG. 7A, first, the driving unit 170 renders the potential difference between the second electrode 150 and the first electrode 140 a negative value (e.g., −15V), such that the electronic writing apparatus 100A is in one of the writing mode and the erase mode. Here, the writing mode is described as an example.

With reference to FIG. 7B, then, in a situation that the potential difference between the second electrode 150 and the first electrode 140 is maintained a negative value, the gap G2 is reduced, such that a portion of the pixel electrodes 180 are electrically connected with the second electrode 150. Accordingly, the voltage of the second electrode 150 is transmitted to the pixel electrodes 180 in contact thereto, and a portion of the display medium layer 130 corresponding thereto is driven by the potential difference between the pixel electrodes 180 and the first electrode 140, thereby completing the writing operation. To be more specific, the object S is used to press the second substrate 120 to move the second electrode 150 on the second substrate 120 to contact a portion of the pixel electrodes 180.

At this moment, in a situation that the potential difference between the second electrode 150 and the first electrode 140 is maintained a negative value, in the micro structures 136 disposed on the pixel electrodes 180 that are in contact with the second electrode 150, the positive charged particles 132 and the negative charged particles 134 are driven by the voltage, transmitted by the second electrode 150 through the pixel electrodes 180, to change positions. For example, in the driven micro structures 136, the black negative charged particles 134 move from the side close to the first substrate 110 toward the side close to the second substrate 120, and the white positive charged particles 132 move from the side close to the second substrate 120 toward the side close to the first substrate 110. Accordingly, when looking at the electronic writing apparatus 100A in the direction from the second substrate 120 to the first substrate 110, a portion of the electronic writing apparatus 100A, which corresponds to the route pressed by the object S, and the part R display black color, and other portions of the electronic writing apparatus 100A which are not pressed by the object S display white color, thereby completing the writing operation.

In the embodiment of FIG. 7A to FIG. 7D, the user uses the second substrate 120 as the writing substrate. That is, as shown in FIG. 7B, the user looks at the electronic writing apparatus 100A in the direction from the second substrate 120 to the first substrate 110. Here, a large portion of an environment light beam L3 needs to pass through the pixel electrodes 180 to be reflected by the charged particles 131 as an image light beam L4 for forming an image in the eyes of the user. Preferably, the pixel electrodes 180 are made of a conductive material having a high light transmittance, such as indium tin oxide, indium zinc oxide, aluminum tin oxide, aluminum zinc oxide, indium germanium zinc oxide, conductive polymers, carbon nanotube, or other suitable materials.

With reference to FIG. 7C, the display medium layer 130 is electrically insulated from the second electrode 150. More specifically, in this embodiment, when the object S leaves the second substrate 120, the second substrate 120 together with the second electrode 150 is separated from the pixel electrodes 180 due to an elastic restoring force of the second substrate 120, so as to recover the gap G2 to the size when no external force is applied on the electronic writing apparatus 100A. Meanwhile, the display medium layer 130 is electrically insulated from the second electrode 150. Then, the potential difference between the second electrode 150 and the first electrode 140 is rendered a positive value (e.g., +15V), such that the electronic writing apparatus 100A is in the erase mode.

With reference to FIG. 7D, then, in a situation that the potential difference between the second electrode 150 and the first electrode 140 is maintained a positive value, the gap G2 is reduced again, such that a portion of the pixel electrodes 180 are electrically connected with the second electrode 150, thereby completing the erasing operation. To be more specific, in this embodiment, the object S is used to press the second substrate 120 to move the second electrode 150 on the second substrate 120 close to the first substrate 110 and to contact a portion of the pixel electrodes 180. At this moment, the pixel electrodes 180 that are in contact with the second electrode 150 drive the positive charged particles 132 and the negative charged particles 134 in the corresponding micro structures 136, so as to change the positions of the positive charged particles 132 and the negative charged particles 134.

For example, since the potential difference between the second electrode 150 and the first electrode 140 is maintained a positive value, in the portion of the micro structures 136 that are driven, the black negative charged particles 134 move from the side close to the second substrate 120 toward the side close to the first substrate 110, and the white positive charged particles 132 move from the side close to the first substrate 110 toward the side close to the second substrate 120. Accordingly, the portion of the electronic writing apparatus 100A, which corresponds to the route pressed by the object S, and the part R are restored to white, thereby completing the erasing operation.

### Third Embodiment

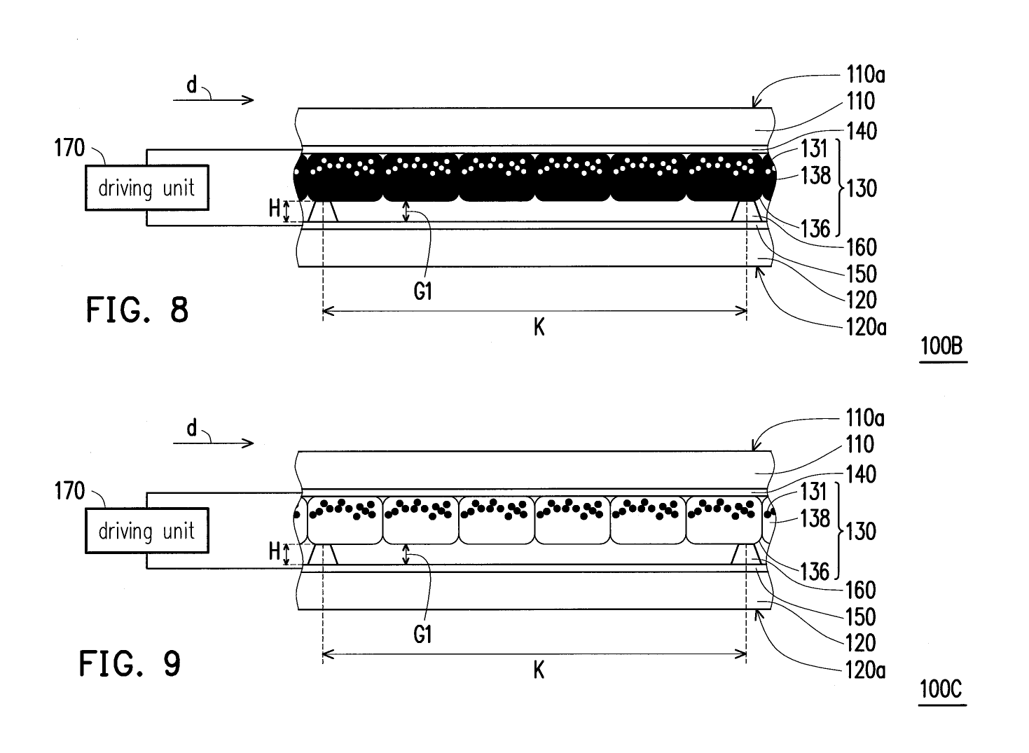

FIG. 8 is a schematic cross-sectional view of an electronic writing apparatus according to the third embodiment of the invention. With reference to FIG. 8, an electronic writing apparatus 100B of this embodiment is similar to the electronic writing apparatus 100 of the first embodiment. Thus, the same components are assigned with the same reference numerals. The difference between the electronic writing apparatus 100B and the electronic writing apparatus 100 is explained hereinafter while the common parts will not be repeated again.

A difference between the electronic writing apparatus 100B of this embodiment and the electronic writing apparatus 100 of the first embodiment lies in that: the display medium layer 130 of the electronic writing apparatus 100B is slightly different from the display medium layer 130 of the electronic writing apparatus 100. Specifically, in this embodiment, the display medium layer 130 also includes a plurality of charged particles 131, an electrophoretic liquid 138, and a plurality of micro structures 132. Each of the micro structures 136 surrounds a portion of the charged particles 131 and a portion of the electrophoretic liquid 138. What differs this embodiment from the first embodiment is that: the charged particles 131 have the same electric property. The charged particles 131 are all positive or negative.

The charged particles 131 have a color that is different from a color of the electrophoretic liquid 138. For example, in this embodiment, the charged particles 131 are white and the electrophoretic liquid 138 is black. However, the invention is not limited to the above. FIG. 9 is a schematic cross-sectional view of an electronic writing apparatus according to another embodiment of the invention. With reference to FIG. 9, in an electronic writing apparatus 100C, the charged particles 131 may be black while the electrophoretic liquid 138 may be white. It should be noted that the color of the charged particles 131 and the color of the electrophoretic liquid 138 are not limited to black and white. In other embodiments, the charged particles 131 and the electrophoretic liquid 138 may be black, white, or any other two colors (e.g., red, blue, green, yellow, etc.) that are distinguishable to the user's naked eyes.

The electronic writing apparatuses 100C and 100B of FIG. 8 and FIG. 9 achieve effects and have advantages similar to those of the electronic writing apparatus 100, and thus will not be repeated hereinafter. The driving methods for the electronic writing apparatuses 100C and 100B are the same as the driving method for the electronic writing apparatus 100, and thus will not be repeated hereinafter.

### Fourth Embodiment

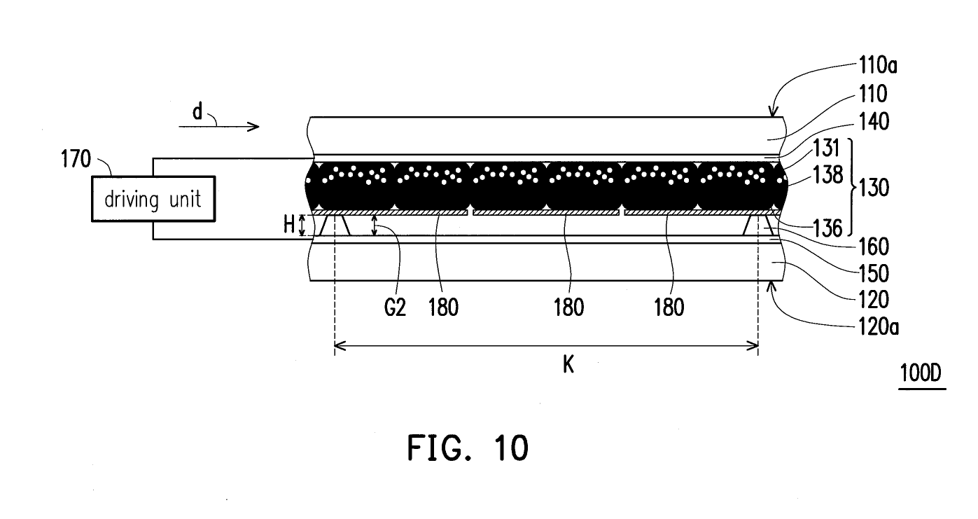

FIG. 10 is a schematic cross-sectional view of an electronic writing apparatus according to the fourth embodiment of the invention. With reference to FIG. 10, an electronic writing apparatus 100D of this embodiment is similar to the electronic writing apparatus 100A of the second embodiment. Thus, the same components are assigned with the same reference numerals. The difference between the electronic writing apparatus 100D and the electronic writing apparatus 100A is explained hereinafter while the common parts will not be repeated again.

A difference between the electronic writing apparatus 100D of this embodiment and the electronic writing apparatus 100A of the second embodiment lies in that: the display medium layer 130 of the electronic writing apparatus 100D is slightly different from the display medium layer 130 of the electronic writing apparatus 100A. Specifically, in this embodiment, the display medium layer 130 also includes a plurality of charged particles 131, an electrophoretic liquid 138, and a plurality of micro structures 132. Each of the micro structures 136 surrounds a portion of the charged particles 131 and a portion of the electrophoretic liquid 138. What differs this embodiment from the first embodiment is that: the charged particles 131 have the same electric property. The charged particles 131 are all positive or negative.

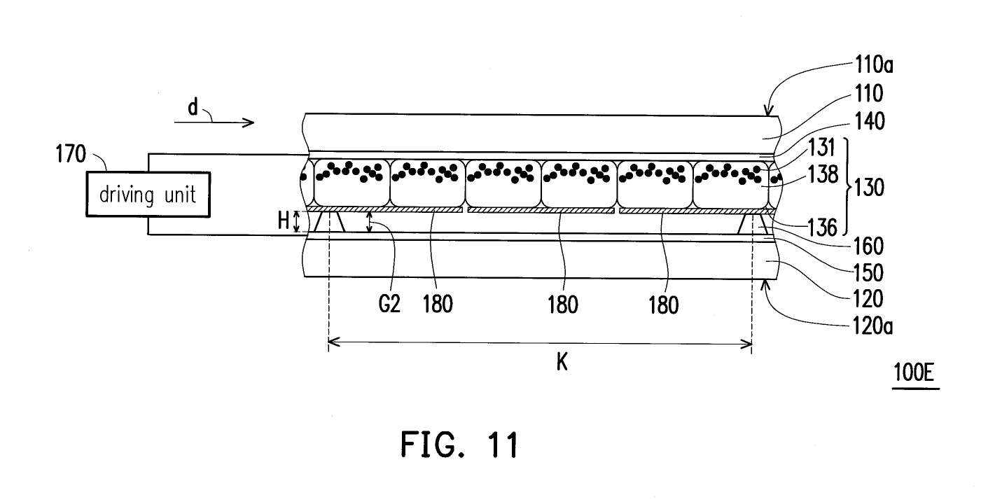

The charged particles 131 have a color that is different from a color of the electrophoretic liquid 138. For example, in this embodiment, the charged particles 131 are white and the electrophoretic liquid 138 is black. However, the invention is not limited to the above. FIG. 11 is a schematic cross-sectional view of an electronic writing apparatus according to another embodiment of the invention. With reference to FIG. 11, in an electronic writing apparatus 100E, the charged particles 131 may be black while the electrophoretic liquid 138 may be white. It should be noted that the color of the charged particles 131 and the color of the electrophoretic liquid 138 are not limited to black and white. In other embodiments, the charged particles 131 and the electrophoretic liquid 138 may be black, white, or any other two colors (e.g., red, blue, green, yellow, etc.) that are distinguishable to the user's naked eyes. The electronic writing apparatuses 100D and 100E of FIG. 10 and FIG. 11 achieve effects and have advantages similar to those of the electronic writing apparatus 100A, and thus will not be repeated hereinafter. In addition, the driving methods for the electronic writing apparatuses 100D and 100E are the same as the driving method for the electronic writing apparatus 100A, and thus will not be repeated hereinafter.

To conclude the above, in the electronic writing apparatus according to an embodiment of the invention, multiple spacers are disposed between the display medium layer and the second electrode for maintaining the gap between the display medium layer and the second electrode. This gap is reduced when the electronic writing apparatus is pressed by the user, such that the second electrode drives a portion of the display medium layer corresponding thereto. With the aforementioned configuration, using the electronic writing apparatus together with the suitable driving method allows the user to partially erase the writing in the designated area, which is more convenient for the user.

In the electronic writing apparatus of another embodiment of the invention, the pixel electrode array is disposed between the spacers and the display medium layer. Because of the configuration of the pixel electrode array, a portion of the display medium layer leant against by the spacers can still be driven by the voltage of the second electrode to be operated by the user.

It will be apparent to those skilled in the art that various modifications and variations can be made to the structure of the disclosed embodiments without departing from the scope or spirit of the disclosure. In view of the foregoing, it is intended that the disclosure covers modifications and variations of this disclosure provided they fall within the scope of the following claims and their equivalents.

What is claimed is:

1. An electronic writing apparatus, comprising:
a first substrate;
a second substrate disposed opposite to the first substrate;
a display medium layer disposed between the first substrate and the second substrate and comprising a plurality of charged particles, an electrophoretic liquid, and a plurality of micro structures, and each of the micro structures surrounding a portion of the charged particles and a portion of the electrophoretic liquid;
a first electrode disposed between the first substrate and the display medium layer;
a second electrode disposed between the display medium layer and the second substrate; and
a plurality of spacers disposed between the display medium layer and the second electrode and leaning against a portion of the micro structures to form a changeable gap between the display medium layer and the second electrode.

2. The electronic writing apparatus according to claim 1, further comprising:
a pixel electrode array disposed between the spacers and the display medium layer and comprising a plurality of pixel electrodes separated from each other.

3. The electronic writing apparatus according to claim 2, wherein at least one of the pixel electrodes is electrically connected with the second electrode when the changeable gap is reduced.

4. The electronic writing apparatus according to claim 1, wherein the charged particles comprise a plurality of positive charged particles and a plurality of negative charged particles, and a color of the positive charged particles is different from a color of the negative charged particles.

5. The electronic writing apparatus according to claim 4, wherein the color of the positive charged particles is one of white and black, and the color of the negative charged particles is the other one of white and black.

6. The electronic writing apparatus according to claim 4, wherein the electrophoretic liquid is transparent.

7. The electronic writing apparatus according to claim 1, wherein the charged particles are a plurality of positive charged particles or a plurality of negative charged particles, and the color of the charged particles is different from a color of the electrophoretic liquid.

8. The electronic writing apparatus according to claim 7, wherein the color of the charged particles is one of white and black.

9. The electronic writing apparatus according to claim 8, wherein the color of the electrophoretic liquid is the other one of white and black.

10. The electronic writing apparatus according to claim 7, wherein the electrophoretic liquid is colored.

11. The electronic writing apparatus according to claim 1, wherein each of the micro structures is a micro-capsule or a micro-cup.

12. The electronic writing apparatus according to claim 1, wherein at least one micro structure that exists between two adjacent spacers is not leant against by any spacer.

13. The electronic writing apparatus according to claim 1, further comprising:
a driving unit electrically connected with the first electrode and the second electrode, wherein the driving unit renders a potential difference between the second electrode and the first electrode a negative value such that the electronic writing apparatus is in one of a writing mode and an erase mode, and the driving unit renders the potential difference between the second electrode and the first electrode a positive value such that the electronic writing apparatus is in the other one of the writing mode and the erase mode.

14. A driving method, adapted for driving an electronic writing apparatus which comprises a first substrate, a second substrate disposed opposite to the first substrate, a display medium layer disposed between the first substrate and the second substrate, a first electrode disposed between the first substrate and the display medium layer, a second electrode disposed between the display medium layer and the second substrate, and a plurality of spacers disposed between the display medium layer and the second electrode, wherein the display medium layer comprises a plurality of charged particles, an electrophoretic liquid, and a plurality of micro structures; each of the micro structures surrounds a portion of the charged particles and a portion of the electrophoretic liquid; and the spacers lean against a portion of the micro structures to form a changeable gap between the display medium layer and the second electrode, the driving method comprising:
rendering a potential difference between the second electrode and the first electrode a negative value such that the electronic writing apparatus is in one of a writing mode and an erase mode; and
when the electronic writing apparatus is in one of the writing mode and the erase mode, reducing the gap such that a portion of the display medium layer is driven by the second electrode.

15. The driving method according to claim 14, wherein the step of reducing the gap such that the portion of the display medium layer is driven by the second electrode comprises:
pressing the first substrate with an object to bend the portion of the display medium layer toward the second substrate to be in contact with the second electrode; or pressing the second substrate with the object to bend the second substrate toward the first substrate to cause the second electrode to be in contact with the portion of the display medium layer.

16. The driving method according to claim 14, wherein the electronic writing apparatus further comprises a pixel electrode array disposed between the spacers and the display medium layer, and the pixel electrode array comprises a plurality of pixel electrodes separated from each other; and the step of reducing the gap such that the portion of the display medium layer is driven by the second electrode comprises:
pressing the first substrate with an object to move at least one of the pixel electrodes toward the second substrate to be in contact with the second electrode; or pressing the second substrate with the object to bend the second substrate toward the first substrate to cause the second electrode to be in contact with at least one of the pixel electrodes.

17. The driving method according to claim 14, further comprising:
electrically insulating the display medium layer from the second electrode;
rendering the potential difference between the second electrode and the first electrode a positive value such that the electronic writing apparatus is in the other one of the writing mode and the erase mode; and
when the electronic writing apparatus is in the other one of the writing mode and the erase mode, reducing the gap such that a portion of the display medium layer is driven by the second electrode.
